(19) United States
(12) Patent Application Publication
(10) Pub. No.: US 2019/0057796 A1
(43) Pub. Date: Feb. 21, 2019

(54) WIRE WITH COMPOSITE SHIELD

(71) Applicant: The Charles Stark Draper Laboratory, Inc., Cambridge, MA (US)

(72) Inventors: Sara C. Barron, Cambridge, MA (US); Caprice Gray Haley, Cambridge, MA (US); Anthony Kopa, Cambridge, MA (US); Andrew P. Magyar, Cambridge, MA (US)

(21) Appl. No.: 16/101,842

(22) Filed: Aug. 13, 2018

Related U.S. Application Data
(60) Provisional application No. 62/545,546, filed on Aug. 15, 2017.

(51) Int. Cl. H01B 11/18; H01B 13/20; H01B 13/26

(52) U.S. Cl. CPC H01B 11/1813; H02G 1/128; H01B 13/2626; H01B 13/20

(57) ABSTRACT

A wire includes an elongate conductive core wire, an elongate insulating layer disposed on and surrounding the elongate conductive core wire, an elongate conductive shield wire disposed adjacent to the insulating layer and the elongate conductive core wire, an elongate conductive shield layer disposed on the insulating layer and on the conductive shield wire such that the elongate insulating layer, the elongate conductive core wire, and the elongate conductive shield wire are embedded in the elongate conductive shield layer, the elongate conductive shield wire being electrically connected to the elongate conductive shield layer.

### RELATED APPLICATIONS

This application claims the benefit of U.S. Provisional Application 62/545,546, filed on Aug. 15, 2017, the contents of which is incorporated herein by reference.

### BACKGROUND

This invention relates to a micro-coaxial wire with a composite shield.

Coaxial wires include a coaxial arrangement of a conductive core wire, an insulating layer deposited on the conductive core wire, and a conductive shield layer deposited on the insulating layer.

### SUMMARY

In a general aspect, a wire includes an elongate conductive core wire, an elongate insulating layer disposed on and surrounding the elongate conductive core wire, an elongate conductive shield wire disposed adjacent to the insulating layer and the elongate conductive core wire, an elongate conductive shield layer disposed on the insulating layer and on the conductive shield wire such that the elongate insulating layer, the elongate conductive core wire, and the elongate conductive shield wire are embedded in the elongate conductive shield layer, the elongate conductive shield wire being electrically connected to the elongate conductive shield layer.

Aspects may include one or more of the following features.

The elongate conductive shield layer may have a first removal temperature less than removal temperatures corresponding to the elongate conductive core wire and the elongate conductive shield wire such that at least a portion of the elongate conductive shield layer is removable by application of heat without causing removal of the elongate conductive core wire or the elongate conductive shield wire. The elongate conductive shield layer may include a solder material and the first removal temperature is a melting temperature of the solder material. The elongate insulating layer may have a removal temperature greater than the first removal temperature such that the at least a portion of the elongate conductive shield layer is removable by application of heat without causing removal of the elongate insulating layer between a remaining portion of the elongate conductive shield layer and the elongate conductive core wire.

The elongate conductive shield layer may include a polymer-metal particle composite material that is removable by laser etching. The elongate conductive shield layer may have a first electrical resistance per unit length, the elongate conductive shield wire may have a second electrical resistance per unit length, wherein the second electrical resistance per unit length is less than the first electrical resistance per unit length. A sum of the first electrical resistance per unit length and the second electrical resistance per unit length may be less than or equal to a third electrical resistance per unit length of the conductive core wire. The elongate conductive shield wire may be interlaced with the elongate insulating layer and the elongate conductive core wire. The elongate conductive shield wire may extend parallel to the elongate insulating layer and the elongate conductive core wire.

A number of elongate conductive shield wires may be embedded in the elongate conductive shield layer. A number of elongate conductive core wires may be embedded in the elongate conductive shield layer with a corresponding number of elongate insulating layers disposed on and surrounding the elongate conductive core wires of the number of elongate conductive core wires. A number of elongate conductive core wires may be embedded in the elongate conductive shield layer with the elongate insulating layer disposed on and surrounding the number of elongate conductive core wires.

In another general aspect, a method for preparing a wire includes forming a compound wire including one or more elongate conductive shield wires and an elongate insulated core wire, depositing an elongate conductive shield layer on the compound wire such that the one or more elongate conductive shield wires and the insulated core wire are embedded in the conductive shield layer with the one or more elongate conductive shield wires being electrically connected to the elongate conductive shield layer.

Aspects may include one or more of the following features.

Depositing the elongate conductive shield layer may include plating the elongate conductive shield layer. Plating the elongate conductive shield layer may include applying a plating seed layer to the compound wire and plating the elongate conductive shield layer onto the plating seed layer. Depositing the elongate conductive shield layer may include one or more iterations of coating the compound wire with an un-cured polymer-metal particle composite and curing the polymer-metal particle composite on the compound wire. Curing the polymer-metal particle composite on the compound wire may include applying heat to the polymer-metal particle composite on the compound wire. Curing the polymer-metal particle composite on the compound wire may include applying light to the polymer-metal particle composite on the compound wire.

Forming the compound wire may include interlacing the one or more elongate conductive shield wires with the elongate, insulated core wire. Interlacing the one or more elongate conductive shield wires with the elongate, insulated core wire may include interlacing a number of elongate conductive shield wires with the elongate, insulated core wire. Interlacing the one or more elongate conductive shield wires with the elongate, insulated core wire may include interlacing one elongate conductive shield wire with the elongate, insulated core wire. The method may include removing a portion of the elongate conductive shield layer from a portion of the wire. The removing may include applying heat to the portion of the wire. The removing may include applying light to the portion of the wire. The elongate insulated core wire may include a plating seed layer.

Aspects may have one or more of the following advantages.

Among other advantages, aspects described herein are compatible with removal (e.g., thermal or laser etching) of a shielding layer from a wire prior to bonding a conductive core wire and a conductive shield wire to independent electrical contact points. Removal of the shielding layer ensures that a conductive core wire does not short to ground during the bonding process.

Aspects described herein utilize prefabricated wires of different impedances, which are easily switchable (e.g., based on impedance needs) during fabrication of a miniature multi-wire system.

A conventional coaxial cable has a core, an insulator, and a highly conductive shield layer. The highly conductive shield layer cannot easily be removed using heat or lasers and, even if it is removed, no wire exists for connecting the shield layer to ground or other connection points.

Once solution for making the shield layer more easily removed is to replace the shield layer on the conventional cable with a solder material. However, the solder material would need to be excessively thick to be able to carry return current, because solder isn't as conductive as, for example, copper.

Aspects described herein have a highly conductive shield wire running through a solder-based shield layer. This configuration provides a number of advantages including: 1) the shield layer doesn't need to be excessively thick, because a majority of the return current travels through the shield wire, and 2) the shield wire is useful for attaching the wire to connection points.

Aspects include a shield wire embedded in the shield layer such that, upon removal of the shield layer, the shield wire is available for connecting connection points to ground. The shield wire is attachable to connection points in a variety of configurations. This is advantageous over conventional techniques that use the shield layer itself to connect to connection points. Furthermore, having a highly conductive shield wire embedded in the shield layer reduces the required thickness of the shield layer by providing a highly conductive path over which return current can flow.

Other features and advantages of the invention are apparent from the following description, and from the claims.

### DESCRIPTION OF DRAWINGS

FIG. 1 is an electronic system including miniature coaxial wires.

FIG. 2 is a bare die based electronic system including miniature coaxial wires.

FIG. 3 is a first embodiment of a miniature coaxial wire with a composite shield.

FIG. 4 is a cross-sectional view of the miniature coaxial wire of FIG. 3.

FIG. 5 is the miniature coaxial wire of FIG. 3 with a portion of the shield layer removed.

FIG. 6 is an attachment strategy using the miniature coaxial wire of FIG. 3.

FIG. 7 is a cross-sectional view of a second embodiment of a miniature coaxial wire with a composite shield.

FIG. 8 is a cross-sectional view of a third embodiment of a miniature coaxial wire with a composite shield.

FIG. 9 is a first method for forming a miniature coaxial wire with a composite shield.

FIG. 10 is a second method for forming a miniature coaxial wire with a composite shield.

FIG. 11 is a third method for forming a miniature coaxial wire with a composite shield.

### DESCRIPTION

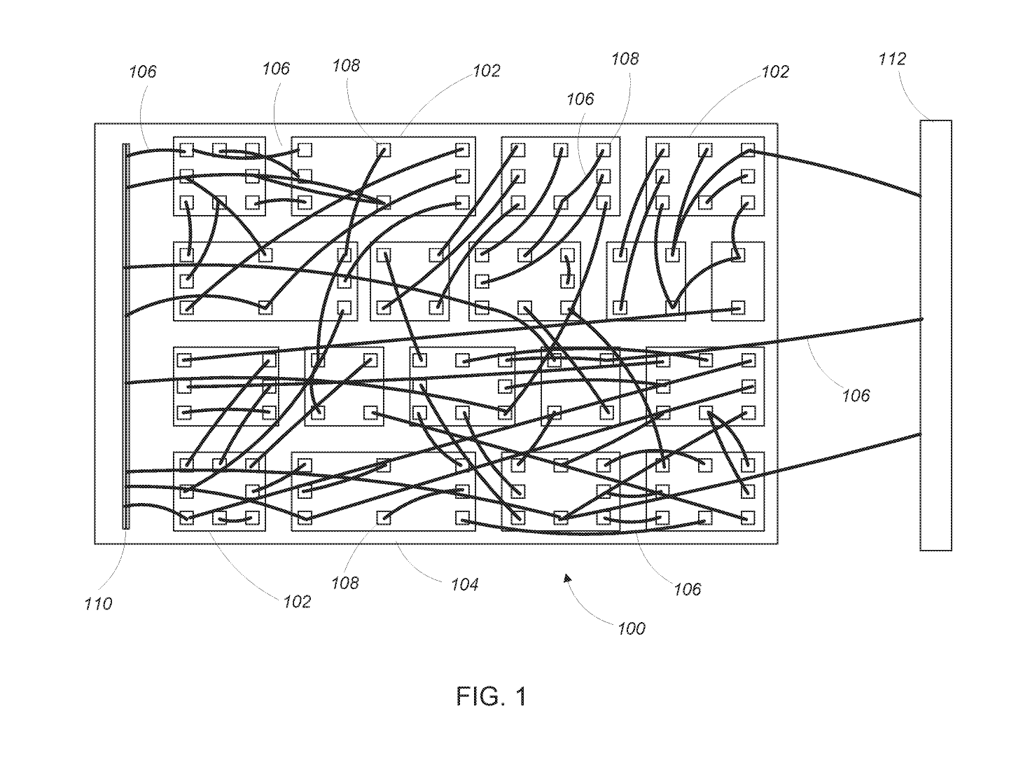

Referring to FIG. 1, an electronic system 100 replaces conductive traces and vias used to connect electrical components on conventional printed circuit boards with a miniature coaxial wiring system. The electronic system 100 includes a number of electronic components 102 (packaged integrated circuits, surface mountable ball grid array packaged integrated circuits, bare integrated circuits, etc.) attached to a substrate 104. Miniature coaxial wires 106 are used to connect connection points 108 (e.g., contact pads, solder balls of a ball grid array, etc.) on the electronic components 102 to connection points associated with a power supply 110, external devices 112, and to other connection points 108 on the same or other electronic components 102.

Given the large variation in electronic components available to engineers, a number of different strategies are employed to attach electronic components, to connection points associated with power supplies, external devices, and connection points on the same or other components, as is described in greater detail below.

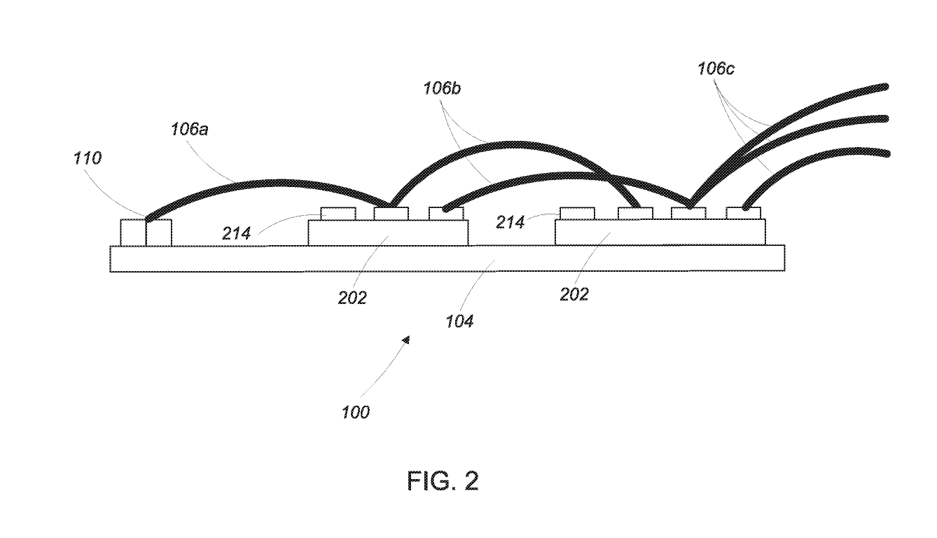

Referring to FIG. 2, in some examples, the electronic system 100 includes a number of bare dies (or ‘dice’) 202 attached to the substrate 104 (e.g., using an adhesive). Surfaces of the bare dies 202 facing away from the substrate 104 include contact pads 214 that are configured to be connected to one or more other connection points, external devices, and/or connection points associated with the power supply 110 using miniature coaxial wires 106 (as is described in greater detail below). For example, in the simple schematic diagram of FIG. 2, one or more first miniature coaxial wires 106a connect contact pads 214 of the bare dies 202 to connection points associated with the power supply 110, one or more second miniature coaxial wires 106b connect contact pads 214 of the bare dies 202 to other contact pads of the bare dies 202, and one or more third miniature coaxial wires 106c connect contact pads 214 of the bare dies 202 to one or more external devices or components.

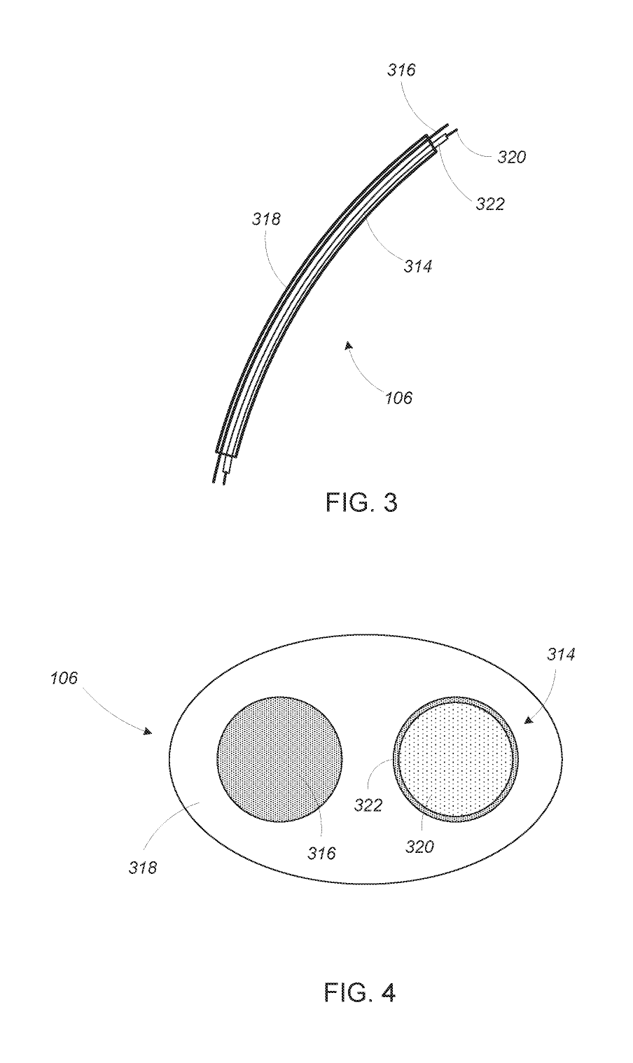

Referring to FIGS. 3 and 4, in some examples, each of the miniature coaxial wires 106 includes an elongate insulated core wire 314, an elongate conductive shield wire 316, and an elongate conductive shield layer 318. The insulated core wire 314 and the conductive shield wire 316 (sometimes collectively referred to as a “compound wire”) are disposed adjacent to one another and are embedded in the conductive shield layer 318. The insulated core wire 314 includes a conductive core wire 320 with an insulating layer 322 disposed thereon such that the conductive core wire 320 is surrounded by the insulating layer 322 along a length of the conductive core wire 320. The conductive shield layer 318 is disposed on the insulated core wire 314 and the shield wire 316 along the length of the miniature coaxial cable 106 such that the insulated core wire 314 and the shield wire 316 are embedded in the conductive shield layer 318. The shield wire 316 is in electrical contact with the conductive shield layer 318. The core wire 320 is not in electrical contact with the conductive shield layer 318 due to the presence of the insulating layer 322. In use, the above-described wire configuration results in the conductive core wire 320 carrying the signal current, the conductive shield wire 316 carrying most of the return current, and the conductive shield layer 318 carrying a portion of the return current not carried by the conductive shield wire 316.

In some examples, the insulated core wire 314 and the conductive shield wire 316 are intertwined (i.e., twisted) with one another. In some examples, the insulated core wire 314 and the conductive shield wire 316 extend parallel to one another (see e.g., FIG. 3). In some examples, the insulating layer 322 of the insulated core wire 314 is separated from the conductive shield wire 316 by the conductive shield layer 318. In some examples, the insulating layer 322 of the insulated core wire 314 is in contact with the conductive shield wire 316.

In some examples, the conductive core wire 320 of the insulated core wire 314 and the conductive shield wire 316 are formed from highly conductive materials such as copper, silver, gold or any other suitable metal or alloy.

In some examples, the conductive shield layer 318 is formed from a conductive material that is removable from the wire 306 without causing removal (e.g., melting or decomposition) of the conductive core wire 320 or the conductive shield wire 316.

In some examples, the conductive shield layer 318 is formed from a conductive material such as solder (e.g., tin-lead or tin-silver-copper) that has a melting temperature (e.g., approximately 188° C.) that is less than melting temperatures (e.g., greater than 1,000° C.) associated with the materials from which the conductive core wire 320 and the conductive shield wire 316 are formed. By applying an amount of thermal energy that is sufficient to melt the solder-based conductive shield layer 318 but is insufficient to melt the conductive core wire 320 and the conductive shield wire 316, the solder-based conductive shield layer 318 can be melted off of the wire 306 without causing melting of the conductive core wire 320 wire the conductive shield wire 316.

In some examples, a melting temperature of the insulating layer 322 is also greater than the melting temperature of the solder-based conductive shield layer 318 such that thermal removal of the solder-based conductive shield layer 318 does not cause removal of the insulating layer 322 from the insulated core wire 314. In some examples, a melting temperature of the insulating layer 322 is less than or equal to the melting temperature of the solder-based conductive shield layer 318 such that thermal removal of the solder-based conductive shield layer 318 also causes removal of the insulating layer 322 from the insulated core wire 314. In some examples, the insulating layer is formed of a dielectric material such as plastic or glass. In general, a thickness of the insulating layer 322 is configured based on an impedance requirement of the signal being carried by the wire 306.

It is noted that the conductive shield layer 318 need not be formed from a metallic thermally removable material, but can be formed of any type of material that can be removed thermally without causing removal of the conductive core wire 320, the conductive shield wire 316, and in some examples, the insulating layer 322.

In some examples, the conductive shield layer 318 is formed from a conductive material such as a polymer-metal particle composite that is removable by a laser etching procedure. The laser etching procedure does not remove the conductive core wire 320 or the conductive shield wire 316, but may remove the insulating layer 322.

In some examples, the materials and cross-sectional areas of the conductive shield wire 316 and the conductive shield layer 318 are selected such that the electrical resistance per unit length of the conductive shield layer 318 is greater than the electrical resistance per unit length of the conductive shield wire 316.

In some examples, the materials and cross-sectional areas of the conductive shield wire 316, the conductive core wire 320, and the conductive shield layer 318 are selected such that a sum of an electrical resistance per unit length of the conductive shield wire 316 and the conductive shield layer 318 is less than or equal to an electrical resistance per unit length of the conductive core wire 320.

In some examples, the micro-coaxial wires have diameters in a range of 25 to 200 microns.

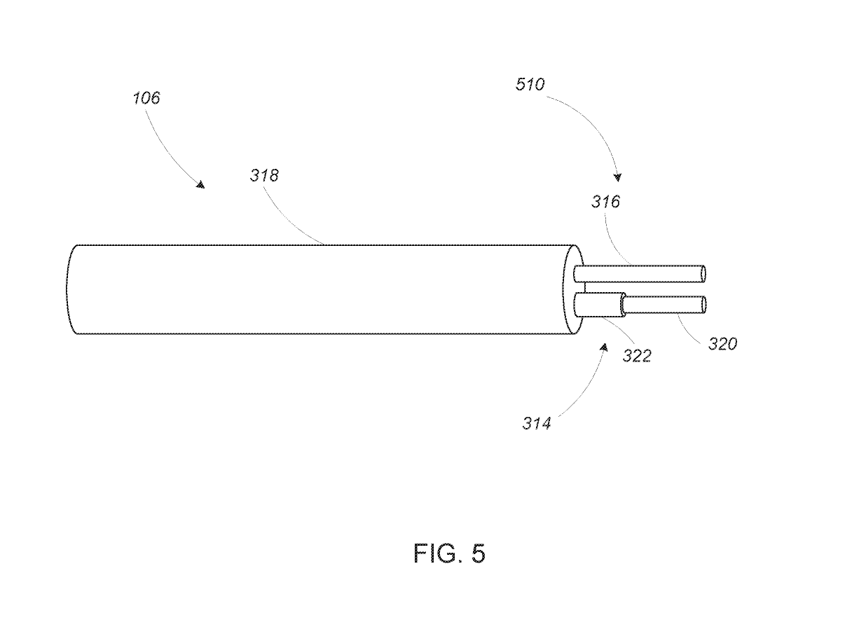

Referring to FIG. 5, after removal of a portion of the conductive shield layer 318 from a first end 510 of the wire 306 (e.g., by applying thermal energy or a laser etching procedure), the insulated core wire 314 including the conductive core wire 320 and the insulating layer 322, and the conductive shield wire 316 are exposed. In some examples, the entire insulating layer 322 remains intact after removal of the portion of the conductive shield layer 318 and a subsequent mechanical stripping step is performed to remove at least a portion of the insulating layer 322 from the conductive core wire 320. In some examples, the entire insulating layer 322 is removed as the portion of the conductive shield layer 318 is removed. In some examples, the entire insulating layer 322 remains intact after removal of the portion of the conductive shield layer 318, during the bonding process, enough of the insulating layer 322 is removed to form a metallic bond between the conductive core wire 320 and an electrical contact pad.

As is described in greater detail below, the exposed portion of the conductive core wire 320 and the exposed portion of the conductive shield wire 316 can be manipulated (e.g., by a wire bonding tool) for bonding the wires to connection points in a circuit.

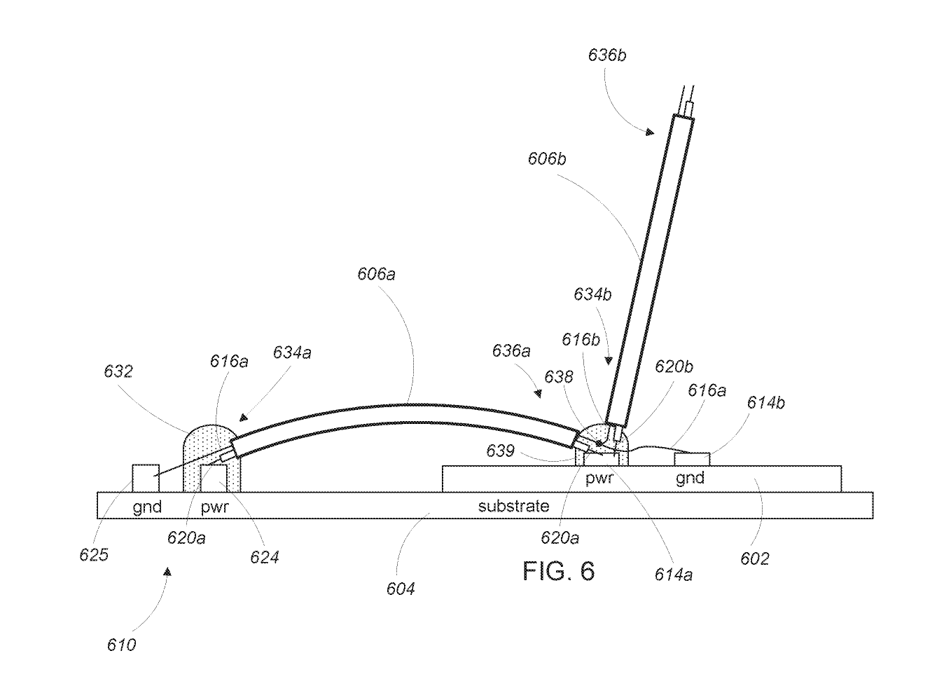

Referring to FIG. 6, in one example of an attachment strategy using the wire 306 of FIG. 3, a bare die 602 is attached to a substrate 604 and has its contact pads 614 connected to the power supply 610 using miniature coaxial wires. In some examples, the contact pads 614 are also connected to external devices (not shown) and to other connection points on other electronic components (not shown) using miniature coaxial wires according to the attachment strategy.

In the configuration of FIG. 6, there are two miniature coaxial wires 606 including a first miniature coaxial wire 606a and a second miniature coaxial wire 606b. The bare die 602 includes a ground (‘gnd’) contact pad 614b and a power (‘pwr’) contact pad 614a.

As is described above, each of the miniature coaxial wires 606 includes an insulated core wire 614 with conductive core wire 620 surrounded by an insulating layer 622, and a conductive shield wire 616, both of which are embedded in a conductive shield layer 618. The conductive core wires 620 of the miniature coaxial wires 606 are attached to contact pads 614 or other connection points (e.g., a power (pwr′) connection point 624 associated with the power supply 610) and the conductive shield wires 616 of the miniature coaxial wires 606 are attached to a ‘gnd’ connection point 625 associated with the power supply 610, all while ensuring that the ‘gnd’ connection point 625 and the ‘pwr’ connection point 624 associated with the power supply 610 are not electrically connected (i.e., short circuited).

In the example of FIG. 6, an exposed portion of the conductive core wire 620a at a first end 634a of the first miniature coaxial wire 606a is attached to the ‘pwr’ connection point 624 associated with the power supply 610 and an exposed portion of the conductive core wire 620a at a second end 636a of the first miniature coaxial wire 606a is attached to the ‘pwr’ contact pad 614a of the bare die 602.

An exposed portion of the conductive shield wire 616a at the first end 634a of the first miniature coaxial wire 606a is attached to the ‘gnd’ connection point 625 associated with the power supply 610 and an exposed portion of the conductive shield wire 616a at the second end 636b of the first miniature coaxial wire 606a is attached to the ‘gnd’ contact pad 614b of the bare die 602.

An exposed portion of the conductive core wire 620b at a first end 634b of the second miniature coaxial wire 606b is attached to the ‘pwr’ contact pad 614a. An exposed portion of the conductive shield wire 616b at the first end 634b of the second miniature coaxial wire 606b is in contact (e.g., is soldered) with the exposed portion of the conductive shield wire 616a at the second end 636a of the first miniature coaxial wire 606a at a connection point 638. Exposed portions of the conductive core wire 620b and the conductive shield wire 616b at a second end 636b of the second miniature coaxial wire 606b are attached to other connection points or external devices (not shown).

In some examples, the connections between the conductive core wires 620, the conductive shield wires 616, and the various connection points are established using welding techniques (e.g., ultrasonic welding, electron beam welding, cold welding, laser welding, resistance welding, thermosonic capillary welding, or thermosonic wedge/peg welding) or soldering techniques.

In the example of FIG. 6, each connection between an exposed portion of a conductive core wire 616 and a connection point is fully encased in an insulator. The connection between the first exposed portion of the conductive core wire 620a at the first end 634a of the first miniature coaxial wire 606a and the ‘pwr’ connection point 624 is fully encased in a first insulator 632. The connection between the second exposed portion of the conductive core wire 620a at the second end 636a of the first miniature coaxial wire 606a and the ‘pwr’ contact pad 614a is fully encased in a second insulator 639. The connection between the first exposed portion of the conductive core wire 620b at the first end 634b of the second miniature coaxial wire 606b and the ‘pwr’ contact pad 614a is also fully encased in the second insulator 639.

In general, in the example of FIG. 6, the term “fully encased” by insulating material relates to both the exposed portions of the conductive core wires 620 and the contact pads 614 or other connection point being entirely covered by the insulating material, without any portion of the conductive core wires 620 and the contact pad 614 or other connection point being left exposed. In general, an exposed part of the insulating layer 622 of the insulated core wire 614 of the miniature coaxial wire 606 is also encased in the insulating material and a part of the conducting shield layer 618 may also be encased in the insulating material. One example of a suitable insulating material is a polyimide material. Of course, other suitable insulating polymers or other materials can be used.

The miniature coaxial wires described above can be used in other attachment strategies such as those described in U.S. patent application Ser. No. 15/592,694, titled “Wiring System,” which is incorporated herein by reference.

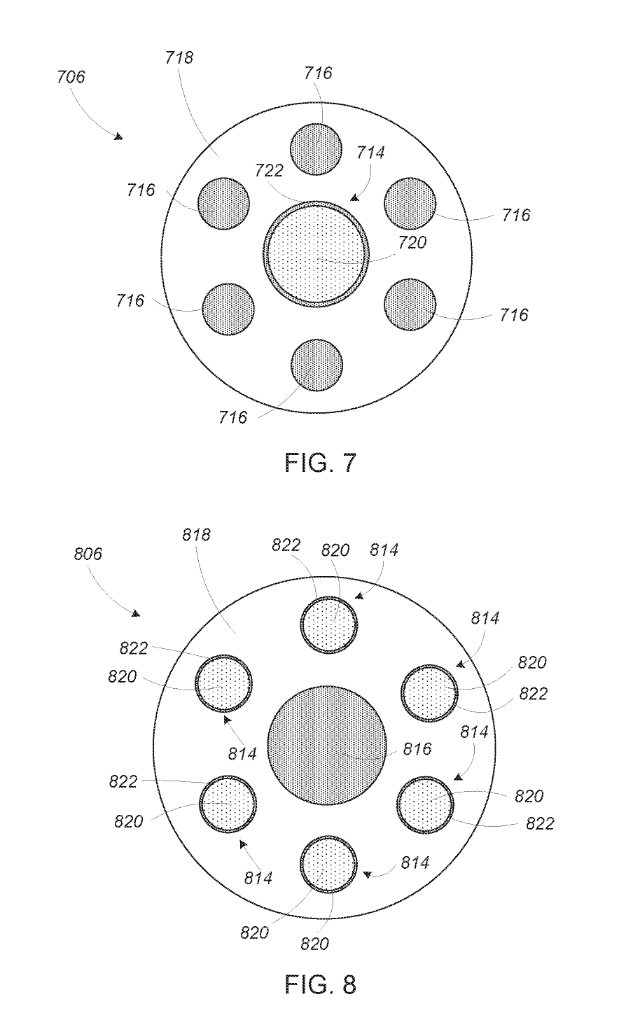

Referring to FIG. 7, in some examples, a miniature coaxial cable 706 includes an insulated core wire 714 and a number of conductive shield wires 716. The insulated core wire 714 and the conductive shield wires 716 are all embedded in a conductive shield layer 718, with the conductive shield wires 716 being in electrical contact with the conductive shield layer 718. The insulated core wire 714 includes a conductive core wire 720 surrounded by an insulating layer 722. The insulating layer 722 prevents electrical contact between the conductive core wire 720 and the conductive shield layer 718 and the conductive shield wires 716.

In some examples, the insulated core wire 714 and the conductive shield wires 716 are intertwined (i.e., twisted or woven) with one another. In some examples, the insulated core wire 714 and the conductive shield wires 716 extend parallel to one another. In some examples, the insulating layer 722 of the insulated core wire 714 is separated from the conductive shield wires 716 by the conductive shield layer 718. In some examples, the insulating layer 722 of the insulated core wire 714 is in contact with the conductive shield wires 716.

In some examples, the conductive core wire 720 of the insulated core wire 714 and the conductive shield wires 716 are formed from highly conductive materials such as copper, silver, gold or any other suitable metal or alloy.

In some examples, the conductive shield layer 718 is formed from a conductive material that is removable from the wire 706 without causing removal (e.g., melting or decomposition) of the conductive core wire 720 or the conductive shield wires 716.

In some examples, the conductive shield layer 718 is formed from a conductive material such as solder (e.g., tin-lead or tin-silver-copper) that has a melting temperature (e.g., approximately 188° C.) that is less than melting temperatures (e.g., greater than 1,000° C.) associated with the materials from which the conductive core wire 720 and the conductive shield wires 716 are formed. By applying an amount of thermal energy that is sufficient to melt the solder-based conductive shield layer 718 but is insufficient to melt the conductive core wire 720 and the conductive shield wires 716, the solder-based conductive shield layer 718 can be melted off of the wire 706 without causing melting of the conductive core wire 720 or the conductive shield wires 716.

In some examples, a melting temperature of the insulating layer 722 is also greater than the melting temperature of the solder-based conductive shield layer 718 such that thermal removal of the solder-based conductive shield layer 718 does not cause removal of the insulating layer 722 from the insulated core wire 714. In some examples, a melting temperature of the insulating layer 722 is less than or equal to the melting temperature of the solder-based conductive shield layer 718 such that thermal removal of the solder-based conductive shield layer 718 also causes removal of the insulating layer 722 from the insulated core wire 714.

It is noted that the conductive shield layer 718 need not be formed from a metallic thermally removable material, but can be formed of any type of material that can be removed thermally without causing removal of the conductive core wire 720, the conductive shield wires 716, and in some examples, the insulating layer 722.

In some examples, the conductive shield layer 718 is formed from a conductive material such as a polymer-metal particle composite that is removable by a laser etching procedure. The laser etching procedure does not remove the conductive core wire 720 or the conductive shield wires 716, but may remove the insulating layer 722.

In some examples, the materials and cross-sectional areas of the conductive shield wires 716 and the conductive shield layer 718 are selected such that the electrical resistance per unit length of the conductive shield layer 718 is greater than the combined electrical resistance per unit length of the conductive shield wires 716.

In some examples, the materials and cross-sectional areas of the conductive shield wires 716, the conductive core wire 720, and the conductive shield layer 718 are selected such that a sum of an electrical resistance per unit length of the conductive shield wires 716 and the conductive shield layer 718 is less than or equal to an electrical resistance per unit length of the conductive core wire 720.

Referring to FIG. 8, in some examples, a miniature coaxial cable 806 includes a number of insulated core wires 814 and a conductive shield wire 816. The insulated core wires 814 and the conductive shield wire 816 are all embedded in a conductive shield layer 818, with the conductive shield wire 816 being in electrical contact with the conductive shield layer 818. Each of the insulated core wires 814 includes a conductive core wire 820 surrounded by an insulating layer 822. The insulating layer 822 prevents electrical contact between the conductive core wire 820 and the conductive shield layer 818 and the conductive shield wire 816.

In some examples, the insulated core wires 814 and the conductive shield wire 816 are intertwined (i.e., twisted or woven) with one another. In some examples, the insulated core wires 814 and the conductive shield wire 816 extend parallel to one another. In some examples, the insulating layers 822 of the insulated core wires 814 are separated from the conductive shield wire 816 and from one another by the conductive shield layer 818. In some examples, the insulating layers 822 of the insulated core wires 814 are in contact with the conductive shield wire 816.

In some examples, the conductive core wires 820 of the insulated core wires 814 and the conductive shield wire 816 are formed from highly conductive materials such as copper, silver, gold or any other suitable metal or alloy.

In some examples, the conductive shield layer 818 is formed from a conductive material that is removable from the wire 806 without causing removal (e.g., melting or decomposition) of the conductive core wires 820 or the conductive shield wire 816.

In some examples, the conductive shield layer 818 is formed from a conductive material such as solder (e.g., tin-lead or tin-silver-copper) that has a melting temperature (e.g., approximately 188° C.) that is less than melting temperatures (e.g., greater than 1,000° C.) associated with the materials from which the conductive core wires 820 and the conductive shield wire 816 are formed. By applying an amount of thermal energy that is sufficient to melt the solder-based conductive shield layer 818 but is insufficient to melt the conductive core wires 820 and the conductive shield wire 816, the solder-based conductive shield layer 818 can be melted off of the wire 806 without causing melting of the conductive core wires 820 wire the conductive shield wire 816.

In some examples, a melting temperature of the insulating layers 822 is also greater than the melting temperature of the solder-based conductive shield layer 818 such that thermal removal of the solder-based conductive shield layer 818 does not cause removal of the insulating layers 822 from the insulated core wires 814. In some examples, a melting temperature of the insulating layers 822 is less than or equal to the melting temperature of the solder-based conductive shield layer 818 such that thermal removal of the solder-based conductive shield layer 818 also causes removal of the insulating layers 822 from the insulated core wires 814.

It is noted that the conductive shield layer 818 need not be formed from a metallic thermally removable material, but can be formed of any type of material that can be removed thermally without causing removal of the conductive core wires 820, the conductive shield wire 816, and in some examples, the insulating layers 822.

In some examples, the conductive shield layer 818 is formed from a conductive material such as a polymer-metal particle composite that is removable by a laser etching procedure. The laser etching procedure does not remove the conductive core wires 820 or the conductive shield wire 816, but may remove the insulating layers 822.

In some examples, the materials and cross-sectional areas of the conductive shield wire 816 and the conductive shield layer 818 are selected such that the electrical resistance per unit length of the conductive shield layer 818 is greater than the electrical resistance per unit length of the conductive shield wire 816.

In some examples, the materials and cross-sectional areas of the conductive shield wire 816, the conductive core wires 820, and the conductive shield layer 818 are selected such that a sum of an electrical resistance per unit length of the conductive shield wire 816 and the conductive shield layer 818 is less than or equal to a combined electrical resistance per unit length of the conductive core wires 820.

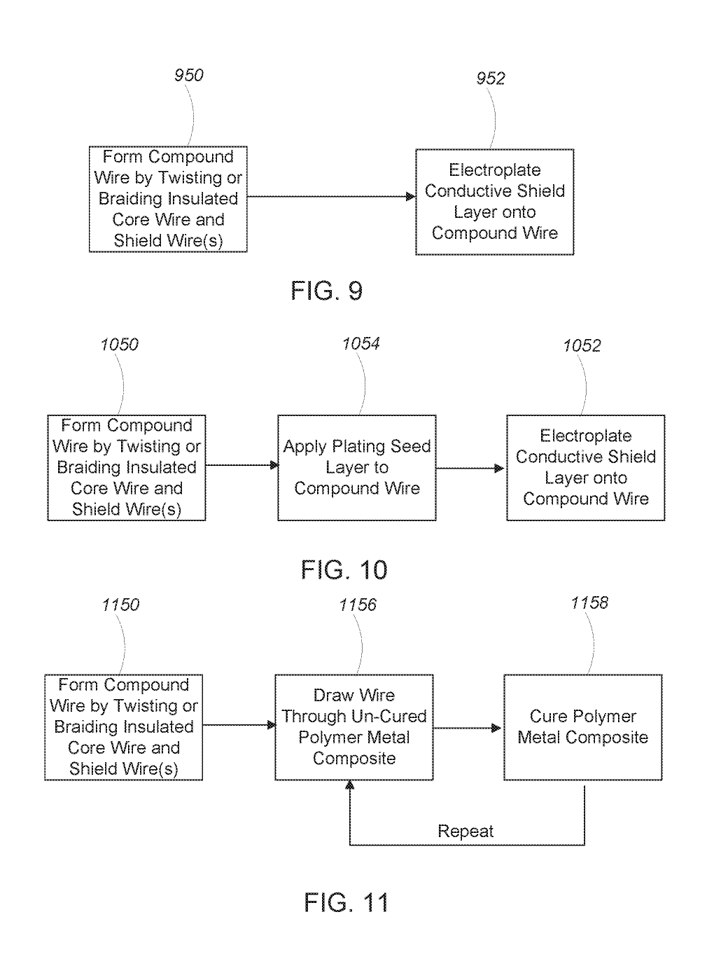

Referring to FIG. 9, in some examples the micro-coaxial wires described above are formed using a two step method. In a first step 950 of the method, a compound wire is formed by twisting or braiding one or more insulated wires with one or more shield wires. In a second step 952, a shield layer (e.g., solder) is deposited on the compound wire using an electroplating procedure.

Referring to FIG. 10, in some examples, the micro-coaxial wires described above are formed using a three-step method. In a first step 1050 of the method, a compound wire is formed by twisting or braiding one or more insulated wires with one or more shield wires. In a second step 1054 of the method, a plating seed layer is deposited (e.g., by evaporation, sputtering, CVD, or ALD) on the compound wire. In a third step 1052 of the method, a shield layer (e.g., solder) is deposited on the plating seed layer using an electroplating procedure. In some examples, the deposition of the plating seed layer (i.e., the second step 1054) is performed prior to twisting or braiding the one or more insulated wires with the one or more shield wires (i.e., the first step 1050).

Referring to FIG. 11, in some examples, the micro-coaxial wires described above are formed using an iterative three step method. In a first step 1150 of the method, a compound wire is formed by twisting or braiding one or more insulated wires with one or more shield wires. In a second step 1156 of the method, a shield layer is formed by drawing the compound wire through an uncured polymer-metal particle composite to coat the compound wire. In a third step 1158 of the method, the polymer-metal composite on the compound wire is cured using a thermal or photo curing process. The second, coating step 1156 and the third, curing step 1158 are repeated until a desired shield layer thickness is achieved.

It is to be understood that the foregoing description is intended to illustrate and not to limit the scope of the invention, which is defined by the scope of the appended claims. Other embodiments are within the scope of the following claims.

What is claimed is:

1. A wire comprising:
an elongate conductive core wire;
an elongate insulating layer disposed on and surrounding the elongate conductive core wire;
an elongate conductive shield wire disposed adjacent to the insulating layer and the elongate conductive core wire;
an elongate conductive shield layer disposed on the insulating layer and on the conductive shield wire such that the elongate insulating layer, the elongate conductive core wire, and the elongate conductive shield wire are embedded in the elongate conductive shield layer, the elongate conductive shield wire being electrically connected to the elongate conductive shield layer.

2. The wire of claim 1 wherein the elongate conductive shield layer has a first removal temperature less than removal temperatures corresponding to the elongate conductive core wire and the elongate conductive shield wire such that at least a portion of the elongate conductive shield layer is removable by application of heat without causing removal of the elongate conductive core wire or the elongate conductive shield wire.

3. The wire of claim 2 wherein the elongate conductive shield layer includes a solder material and the first removal temperature is a melting temperature of the solder material.

4. The wire of claim 2 wherein the elongate insulating layer has a removal temperature greater than the first removal temperature such that the at least a portion of the elongate conductive shield layer is removable by application of heat without causing removal of the elongate insulating layer between a remaining portion of the elongate conductive shield layer and the elongate conductive core wire.

5. The wire of claim 1 wherein the elongate conductive shield layer includes a polymer-metal particle composite material that is removable by laser etching.

6. The wire of claim 1 wherein the elongate conductive shield layer has a first electrical resistance per unit length, the elongate conductive shield wire has a second electrical resistance per unit length, wherein the second electrical resistance per unit length is less than the first electrical resistance per unit length.

7. The wire of claim 6 wherein a sum of the first electrical resistance per unit length and the second electrical resistance per unit length is less than or equal to a third electrical resistance per unit length of the conductive core wire.

8. The wire of claim 1 wherein the elongate conductive shield wire is interlaced with the elongate insulating layer and the elongate conductive core wire.

9. The wire of claim 1 wherein the elongate conductive shield wire extends parallel to the elongate insulating layer and the elongate conductive core wire.

10. The wire of claim 1 wherein a plurality of elongate conductive shield wires is embedded in the elongate conductive shield layer.

11. The wire of claim 1 wherein a plurality of elongate conductive core wires is embedded in the elongate conductive shield layer with a corresponding plurality of elongate insulating layers disposed on and surrounding the elongate conductive core wires of the plurality of elongate conductive core wires.

12. The wire of claim 1 wherein a plurality of elongate conductive core wires is embedded in the elongate conductive shield layer with the elongate insulating layer disposed on and surrounding the plurality of elongate conductive core wires.

13. A method for preparing a wire, the method comprising:
forming a compound wire including one or more elongate conductive shield wires and an elongate insulated core wire;
depositing an elongate conductive shield layer on the compound wire such that the one or more elongate conductive shield wires and the insulated core wire are embedded in the conductive shield layer with the one or more elongate conductive shield wires being electrically connected to the elongate conductive shield layer.

14. The method of claim 13 wherein depositing the elongate conductive shield layer includes plating the elongate conductive shield layer.

15. The method of claim 14 wherein plating the elongate conductive shield layer includes applying a plating seed layer to the compound wire and plating the elongate conductive shield layer onto the plating seed layer.

16. The method of claim 13 wherein depositing the elongate conductive shield layer includes one or more iterations of coating the compound wire with an un-cured polymer-metal particle composite and curing the polymer-metal particle composite on the compound wire.

17. The method of claim 16 wherein curing the polymer-metal particle composite on the compound wire includes applying heat to the polymer-metal particle composite on the compound wire.

18. The method of claim 16 wherein curing the polymer-metal particle composite on the compound wire includes applying light to the polymer-metal particle composite on the compound wire.

19. The method of claim 13 wherein forming the compound wire includes interlacing the one or more elongate conductive shield wires with the elongate, insulated core wire.

20. The method of claim 19 wherein interlacing the one or more elongate conductive shield wires with the elongate, insulated core wire includes interlacing a plurality of elongate conductive shield wires with the elongate, insulated core wire.

21. The method of claim 19 wherein interlacing the one or more elongate conductive shield wires with the elongate, insulated core wire includes interlacing one elongate conductive shield wire with the elongate, insulated core wire.

22. The method of claim 13 further comprising removing a portion of the elongate conductive shield layer from a portion of the wire.

23. The method of claim 22 wherein the removing includes applying heat to the portion of the wire.

24. The method of claim 22 wherein the removing includes applying light to the portion of the wire.

25. The method of claim 13 wherein the elongate insulated core wire comprises a plating seed layer.
